(19) United States
(12) Patent Application Publication
(10) Pub. No.: US 2007/0033306 A1
(43) Pub. Date: Feb. 8, 2007

(54) FIFO-type one-way interfacing device between a master unit and a slave unit, and corresponding master unit and slave unit

(75) Inventors: Sylvain Garnier, Nantes (FR); Thierry Delalande, Nantes (FR); Laurentiu Birsan, Nantes (FR)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: Atmel Nantes SA, Nantes Cedex 3 (FR)

(21) Appl. No.: 11/493,360

(22) Filed: Jul. 26, 2006

(30) Foreign Application Priority Data
Jul. 26, 2005 (FR) 05/07988

(51) Int. Cl. G06F 5/00

(52) U.S. Cl. 710/52

(57) ABSTRACT

An interfacing device (23) of the type enabling one-way interfacing between a master unit (21) and a slave unit (22), includes: a memory plane managed according to a “first in, first out” mode, with write and read pointers, and making it possible to store words coming from the master unit, via an input bus (FIFODin); a bank of output registers capable of containing words read in the memory plane and providing an output signal (FIFODout) capable of being read by the slave unit; a mechanism configured to receive read requests (FIFORdRq=1) coming from the slave unit and write requests (FIFOWr=1) coming from the master unit, each read request requiring the reading of a word group. The interfacing device further includes: a mechanism configured to receive, for each read request, of the size (NbWords) of the word group associated with said read request, size being variable from one read request to the other; and a mechanism configured to acknowledge read requests, generating, for each read request, an acknowledgement signal with a “true” value (FIFORdAck=1) if a number of words at least equal to the size (NbWords) of the word group associated with read request is available on the output signal (FIFODout) of the bank of output registers.

### FIELD OF THE INVENTION

The field of the invention is that of electronic circuits.

### BACKGROUND OF THE INVENTION

More precisely, the invention relates to an interfacing device of the type enabling one-way interfacing between a master unit and a slave unit.

Conventionally, such an interfacing device includes a memory plane managed according to a “first in, first out” mode (or FIFO), with write and read pointers. This memory plane makes it possible to store words coming from the master unit, via an input bus. The interfacing device (hereinafter also called “FIFO memory”) also includes a bank of output registers capable of containing words read in the memory plane, and providing an output signal capable of being read by the slave unit. It receives read requests coming from the slave unit and write requests coming from the master unit. Each read request requires the reading of a word group. A word is one octet, for example.

It is important to note that, in this document, the term “register” must be understood, in a broad sense, as any circuit making it possible to temporarily store a set of bits. Typically, at each rising edge of a clock signal, a register samples and blocks on its output the signal present on its input.

The interfacing device according to the invention has numerous applications, e.g., such as the interfacing between a microprocessor, serving as the master unit, and a co-processor, serving as the slave unit. The co-processor, for example, is a digital signal processor (or DSP).

More generally, in one embodiment, the invention can be applied in any case where the slave unit wishes to read word groups in the interfacing device the size of which (in number of words) varies from one group to the other.

### PRIOR ART

The disadvantages of the prior art will now be presented by way of the particular application cited above and illustrated in FIG. 1, wherein the master and slave units are respectively a microprocessor 1 (hereinafter also called CPU) and a co-processor 2 (hereinafter also called DSP), and wherein the variable-size word groups are instructions 4 that the microprocessor transmits, via the interfacing device 3, to the co-processor, so that it executes them.

More precisely, in order to write words into the memory plane, the microprocessor 1 sends write requests (FIFOWr=1) and places words on the input bus (FIFODin) of the interfacing device 3. In order to read words, the co-processor 2 sends read requests (FIFORd=1) and reads words on the output bus (FIFODout) of the interfacing device 3. The clock (FIFOClk) of the interfacing device 3 is provided by the microprocessor 1.

Indeed, in order to reduce the load of a microprocessor, it is known to use co-processors that process information flows. Each flow between the microprocessor and a co-processor has a high cost that must be minimized.

An instruction (also called command or else transaction) of the microprocessor to the co-processor is composed of an operation code word (or “opcode”) and N operand words (or “data words”), with N≧0. The set of instructions comprises instructions of various sizes (i.e., comprising, for example, a total of one, two, three or four words). These instructions are written in the FIFO-type interfacing device, which enables flexibility in the execution of the microprocessor code and co-processor code.

Conventionally, a first automatic control mechanism exists between the interfacing device 3 and the microprocessor 1: when it detects that the memory plane is full, the interfacing device sends the microprocessor a memory full indication message (FIFOFull=1) in order that the latter stop writing, so as to prevent any overflow. A second automatic control mechanism exists between the interfacing device 3 and the co-processor: when it detects that the memory plane is empty, the interfacing devices sends the co-processor a memory empty indication message (FIFOEmpty=1) in order that the latter stop reading, so as to prevent unnecessary read accesses.

Furthermore, within the memory plane of the interfacing device, it is appropriate to manage the alignment of the words read by the co-processor. Indeed, the interfacing device must store variable-size instructions in its memory plane, and restore them by respecting an alignment, so that, for each instruction, the co-processor receives the operation code word (opcode) possibly followed by one or more operand words that must be correctly aligned in its instruction register.

The current technique for managing this alignment will now be presented briefly in relation to FIG. 3. FIG. 3 shows an example of a memory plane of a standard 64-word size FIFO memory (interfacing device). In the case of a standard FIFO memory, the dimensions are fixed. The number of lines of n-bit words is hardware frozen. Each line includes a specific number of words, equal to the maximum size of an instruction. Thus, in the example of FIG. 3, there are 16 lines of 4 words each (an instruction includes a maximum of 4 words). In order to manage the alignment of the words in the memory plane, the microprocessor systematically writes 4 words in the memory plane for each of the successive instructions, regardless of the actual size of the instruction. To accomplish that, the microprocessor completes the word or words of each instruction with one or more stuffing words (“stuffing” mechanism). Thus, in the case of a standard FIFO memory, the data is already aligned at the output if the FIFO memory provides the information in a parallel manner (i.e., by providing the words 4 by 4, in the aforesaid example). It is important to note that, in the current technique, the co-processor does not provide information about the length of the instruction to the FIFO, because the latter always provides a maximum size vector for an instruction. The co-processor exploits only the significant portion of the vector at the completion of the instruction decoding.

It appears that the dual automatic control mechanism in its current implementation, as well as the known technique for managing alignment, do not constitute an optimal solution for enabling maximum flexibility in filling the memory plane of the interfacing device by means of the microprocessor, or in emptying it by executing the co-processor code.

Indeed, the use of stuffing words for managing the alignment of the instructions in the memory plane prevents all of the memory workspace from being used for the instruction words alone. Furthermore, that increases the number of write accesses that the microprocessor must perform. Finally, that slows down the transfer time of the instructions from the microprocessor to the co-processor, because the memory full (FIFOFull=1) and memory empty (FIFOEmpty=1) indication messages correspond to decisions taken without any anticipation and with too large of a granularity (in the aforesaid example, blocks of 4 words are managed regardless of the actual size of the instructions).

### SUMMARY OF THE INVENTION

An aspect of the invention is an interfacing device of the type enabling one-way interfacing between a master unit and a slave unit. The device includes a memory plane managed according to a “first in, first out” mode, with write and read pointers, and making it possible to store words coming from the master unit, via an input bus (FIFODin). A bank of output registers capable of containing words read in the memory plane provides an output signal (FIFODout) capable of being read by the slave unit. A receiving mechanism configured to receive read requests (FIFORdRq=1) coming from the slave unit and write requests (FIFOWr=1) coming from the master unit, each read request requiring the reading of a word group.

The interfacing device further includes a mechanism configured to receive, for each read request, the size (NbWords) of the word group associated with said read request, said size being variable from one read request to the other, and an acknowledgment mechanism configured to acknowledge read requests, and generate, for each read request, an acknowledgement signal with a “true” value (FIFORdAck=1) if a number of words at least equal to the size (NbWords) of the word group associated with said read request is available on the output signal (FIFODout) of the bank of output registers.

Thus, the description herein provides a completely novel and inventive approach for the interfacing between a master unit and a slave unit, since the an aspect of the invention consists in managing the acknowledgement of each read request (formulated by the slave unit) by taking into account the size of the word group whose reading is required by said request (said size being provided by the slave unit).

In other words, in the aforesaid particular application, the interfacing device manages the acknowledgement of each read request formulated by the co-processor by taking into account the size of the instruction to be read in response to this request.

In this way, (contrary to the prior art technique discussed above) it is no longer necessary that the word groups be aligned in the memory plane of the interfacing device, and therefore it is no longer necessary to use stuffing words. Thus, it is possible to overcome many if not all of the above-mentioned disadvantages associated with the use of stuffing words.

It shall be noted that, in comparison with a master unit of the prior art, the master unit herein described does not have to be modified at the hardware level, but only at the software level. Indeed, it is simplified so as to transmit only useful words, without any stuffing words. It is to be noted that the master unit does not have to know the size of the word groups that it writes in the interfacing device and can therefore write the words of the same group either one or more times.

In comparison with a slave unit of the prior art, the slave unit herein described is modified, in particular so as to be able to transmit the size information for each word group to be read, and to receive and process the acknowledgement messages sent by the interfacing device.

Another aspect of the invention relates to a slave unit of the type designed to cooperate with a master unit via a one-way interfacing device. The slave unit includes a transmitting mechanism configured to transmit read requests (FIFORdRq=1) to the interfacing device, each read request requiring the reading of a word group. A read mechanism is configured to read an output signal (FIFODout) of a bank of output registers capable of containing words read in a memory plane of the interfacing device.

The slave unit further includes a mechanism configured to transmit, for each read request, the size (NbWords) of the word group associated with said read request, said size being variable from one read request to the other, and a mechanism configured to read, for each read request, an acknowledgement signal (FIFORdAck) coming from the interfacing device and having a “true” value (FIFORdAck=1) if a number of words at least equal to the size (NbWords) of the word group associated with said read request is available on the output signal (FIFODout) of the bank of output registers.

Another aspect of the invention also relates to a master unit, of the type designed to cooperate with a slave unit via a one-way interfacing device. The master unit includes a mechanism configured to transmit write requests (FIFOWr=1) to the interfacing device, a mechanism configured to transmit, on an input bus (FIFODin) of the interfacing device, data words to be written in the interfacing device, and a mechanism configured to provide, for each write request, an abort signal (FIFOWrAbort) coming from the interfacing device and having a “true” value (FIFOWrAbort=1) if said write request must be aborted by the master unit.

It should be noted the mechanism configured to transmit data words sends only words contained in word groups intended to be read by the slave unit, no stuffing word being added.

Some of the advantages of the afore-mentioned include providing a FIFO-type interfacing device between a master unit and a slave unit that does not require the writing of stuffing words and that thus makes it possible to optimise the use of the memory plane of the interfacing device. In addition, the interfacing device enables optimal management of the transfer times between the master unit and the slave unit, via the interfacing device. Furthermore, the interfacing device can be simple to implement and be inexpensive.

Yet another advantage is that the interfacing device enables the master unit to write data either one or more times.

Yet another advantage is that the interfacing device enables instantaneous availability of the read data as soon as it is valid (i.e., includes the anticipated number of elementary words).

### LIST OF THE FIGURES

Other characteristics and advantages of the invention will become apparent upon reading the following description of an embodiment of the invention, given for illustrative and non-limiting purposes, and of the appended drawings, in which:

FIG. 1 shows a simplified functional block diagram of a system of the prior art, wherein an interfacing device is placed between a master unit and a slave unit;

FIG. 2 shows a simplified functional block diagram of a particular embodiment of the system, wherein an interfacing device is placed between a master unit and a slave unit;

FIG. 3 shows an example of filling a 64-word size memory plane of an interfacing device of the prior art (standard FIFO memory);

FIG. 4 shows an example of filling a 64-word size memory plane of an interfacing device;

FIG. 5 is a logic diagram of a first particular embodiment of the interfacing device;

FIG. 6 is a logic diagram of a second particular embodiment of the interfacing device;

FIG. 7 shows the implementation of a through transit mechanism (“pass-through”) appearing in FIGS. 5 and 6;

FIG. 8 shows signal timing charts illustrating an example of the passage to the “true” value of a write abort signal (FIFOWrAbort=1) generated by an interfacing device;

FIG. 9 shows signal timing charts illustrating an example of the maintaining at the “false” value of a write abort signal (FIFOWrAbort=0) generated by an interfacing device;

FIG. 10 shows signal timing charts illustrating an example of the passage to the “true” value of a read acknowledgement signal (FIFORdAck=1) generated by an interfacing device; and

FIG. 11 shows signal timing charts illustrating an example of the passage to the “false” value of a read acknowledgement signal (FIFORAck=0) generated by an interfacing device.

### DETAILED DESCRIPTION

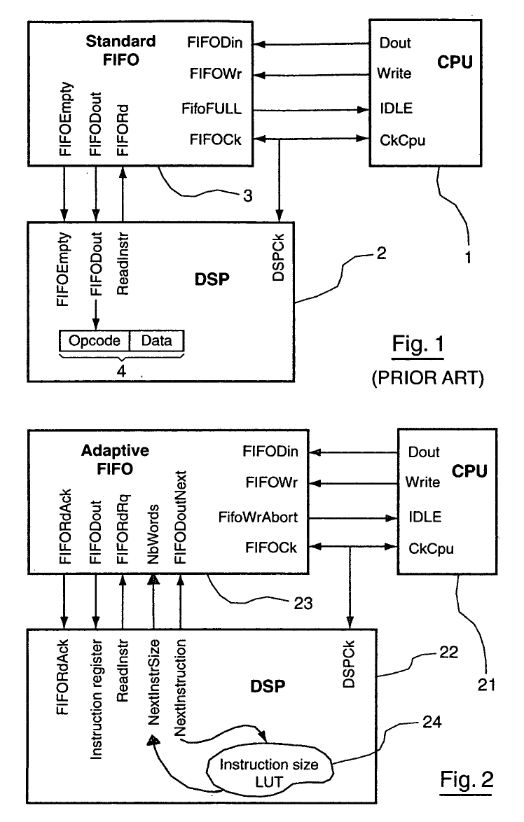

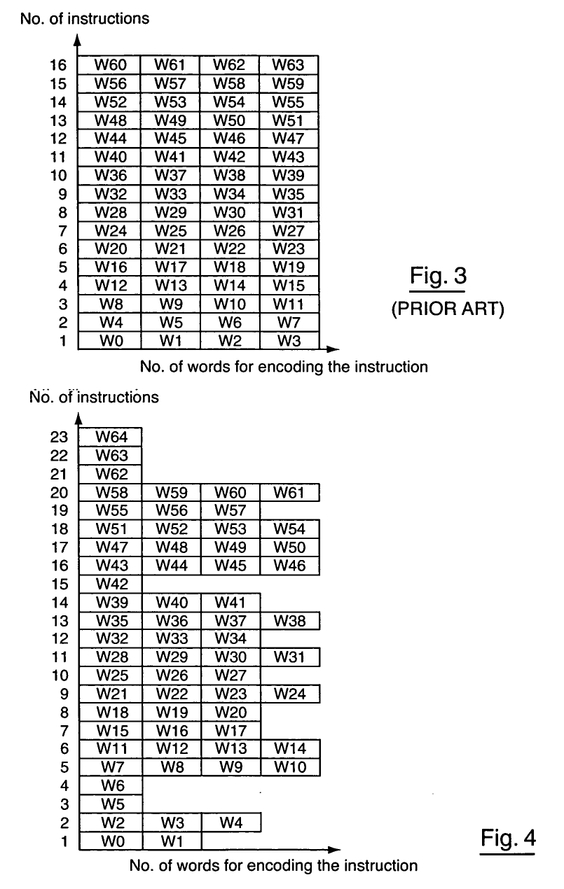

FIGS. 1 and 3 relate to the technique of the prior art and have already been described above.

In all of the figures of this document, identical elements or signals are designated by the same alphanumeric reference.

Thus, an aspect of the invention relates to a technique for interfacing between a master unit and a slave unit via a FIFO-type one-way interfacing device capable of optimally managing the writing and reading of word groups variable in size from one group to the other.

Particular Application: Microprocessor/Co-Processor Interfacing

For illustrative and non-limiting purposes, the remainder of the description will consider the case of the following particular application, already mentioned above and illustrated in FIG. 2: the interfacing device 23 (also called adaptive FIFO) is placed between a microprocessor 21 (also called CPU), serving as the master unit, and a co-processor 22 (also called DSP), serving as the slave unit. Each word group is an instruction comprising an operation code word (opcode) and N operand words, with N≧0. It is clear, however, that the invention is not limited to this particular application.

The microprocessor (master) writes in the memory plane in a synchronous and successive manner, without prior knowledge of the number of words to be written for each instruction. Reading is done on the co-processor side (slave) in a combinatorial manner.

Description of the Contributing Mechanisms

Structural Description of the Interfacing Device

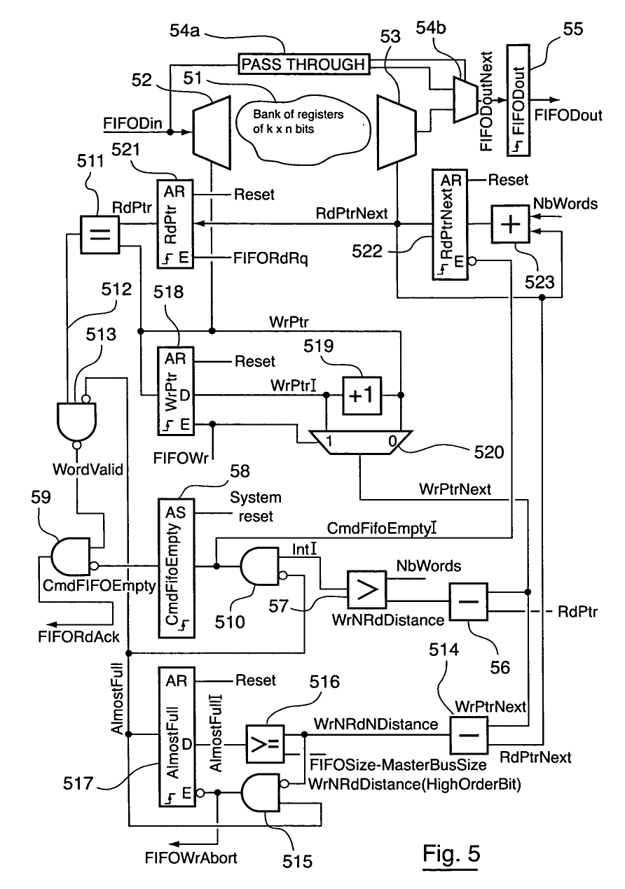

A particular first embodiment of the interfacing device will now be presented in relation to the logic diagram of FIG. 5.

The interfacing device includes a memory plane 51 (e.g., a bank of registers) composed of k elementary n-bit words (e.g., k=64 and n=8 for a memory plane of 64 octets).

A first address decoder (shown by a multiplexer referenced as 52, and also called means of accessing the memory plane during writing) makes it possible to control the writing in the memory plane 51 of data present on the input bus (FIFODin), based on an active value (WrPtr) of the write pointer.

A second address decoder (shown by a multiplexer referenced as 53, and also called means of accessing the memory plane during reading) make it possible to control the reading of data in the memory plane 51, based on the anticipated value (RrPtrNext) of the read pointer. The output signal of the second controller is provided to a bank of output registers 55 that generates an output signal (FIFODout) capable of being read by the co-processor and that is a sampled and blocked value (at each stroke of the clock) of the signal FIFODoutNext present on its input.

A through transit mechanism (“pass-through”) 54a, 54b (discussed in detail below) makes it possible to directly place (in a single clock stroke) the contents of the input bus (FIFODin) on the input of the bank of output registers 55.

Thus, the signal FIFODout (also called output bus of the interfacing device) contains either the data coming from the memory plane 51, or that coming directly from the input bus (FIFODin).

By way of example, it is hereinafter assumed that the size of the input bus (FIFODin) is equal to one elementary word and the size of the output bus (FIFODout) is equal to four elementary words.

As shown in FIG. 2, the interfacing device provides the co-processor with the signal FIFODoutNext present at the input of the bank of output registers 55, so that, while the interfacing device is serving an active read request, the co-processor might obtain, in an anticipatory way, an assumed value of the instruction associated with the next read request and provide the interfacing device with the size (NbWords) of the instruction associated with this next read request. The co-processor obtains the size (NbWords) of the next read request by decoding the opcode word of the next instruction (present on FIFODoutNext), then by using the decoded opcode word to query a table of correspondence (LookUp Table) between the opcode words and the instruction sizes. This mechanism is referenced as 24 in FIG. 2.

The interfacing device further includes means of acknowledging read requests, generating, for each read request, an acknowledgment signal with a “true” value (FIFORdAck=1), if a number of words at least equal to the size (NbWords) of the instruction associated with this read request is available on the output signal (FIFODout) of the bank of output registers.

These acknowledgement means include:

a computing mechanism 56 configured to compute a first distance (WrNRdDistance) between, on the one hand, an anticipated value (WrPtrNext) of the write pointer, an advance clock stroke, and, on the other hand, an active value (RdPtr) of the read pointer;

a comparator 57 making it possible to compare the size (NbWords) of the instruction associated with an active read request with the first distance, so that if the size is not greater than the first distance, the first means of comparison generate an intermediate combinatorial signal with a “false” value (IntI=0);

a second mechanism consisting of a logic gate AND 510 of which a first input receives the intermediate combinatorial signal (IntI) and a second inverted input receives a sequential, almost full memory indication signal (AlmostFull). Mechanism 510 generates a combinatorial memory empty indication signal with the “true” value (CmdFifoEmptyI=1) only if the size (Nbwords) is greater than the first distance (i.e., if IntI=1), and if the sequential, almost full memory indication signal assumes the “false” value (AlmostFull=0));

a first intermediate register 58 making it possible to sample and block the combinatorial memory empty indication signal (CmdFifoEmptyI), in order to provide at its output a sequential, memory empty indication signal (CmdFifoEmpty);

a first mechanism consisting of a logic gate AND 59 of which a first inverted input receives the sequential, memory empty indication signal (CmdFifoEmpty) and a second input receives a validity signal for the computation of the first distance (WordValid). Mechanism 59 generates the acknowledgement signal with the “true” value (FIFORdAck=1) if the first intermediate register 58 provides at its output the sequential, memory empty indication signal with the “false” value (CmdFifoEmpty=0), and if the validity signal of the computation of the first distance has the “true” value (WordValid=1);

In order to generate the validity signal for the computation of the first distance (WordValid), the interfacing device includes:

a detector 511 configured to detect an alignment of the active values (WrPtr, RdPtr) of the write and read pointers, generating an alignment signal 512 with the “true” value, in the case of alignment;

a third mechanism consisting of a logic gate AND 513 of which a first input receives the alignment signal 512 and a second inverted input receives the sequential, almost full memory indication signal (AlmostFull). Mechanism 513 generates the validity signal for the computation of the first distance with the “false” value (WordValid=0) only if the alignment signal 512 assumes the “true” value and if the sequential, almost full memory indication signal assumes the “false” value (AlmostFull=0).

The interfacing device further includes means of aborting write requests, generating an abort signal (FIFOWrAbort) and themselves comprising:

a computing mechanism 514 is configured to compute a second distance (WrNRdNDistance) between anticipated values (WrPtrNext, RdPtrNext) of the write and read pointers;

a fourth mechanism consisting of a logic gate AND 515 of which a first inverted input receives the high-order bit of the second distance (WrNRdNDistance (HighorderBit)) and a second input receives the sequential, almost full memory Mechanism 515 generates the abort signal with the “true” value (FIFOWrAbort=1) if the sequential, almost full memory indication signal assumes the “true” value (AlmostFull=1), while the second distance is near zero (WrNRdNDistance (HighorderBit)=0).

The means of generating a sequential, almost full memory indication signal (AlmostFull) themselves include:

second comparator 516, making it possible to compare the second distance (WrNRdNDistance) with a specific threshold value (e.g., the difference between the size of the memory plane and the size of the input bus: FIFOSize-MasterBusSize, so that, if the second distance is greater than or equal to the threshold value, where the second comparator generates a combinatorial, almost full memory indication signal with a “true” value (AlmostFullI=1);

a second intermediate register 517 making it possible to sample and block the combinatorial almost full memory indication signal (AlmostFullI) in order to provide at its output said sequential, almost full memory indication signal (AlmostFull). This second intermediate register has an inverted activation input (E) receiving the abort signal (FIFOWrAbort).

In order to generate the active (WrPtr) and anticipated (WrPtrNext) values of the write pointer, the interfacing device includes:

a third intermediate register 518 making it possible to sample and block a combinatorial value of the write pointer (WrPtrI), in order to provide at its output the active value (WrPtr) of the write pointer. This third intermediate register has an activation input (E) receiving the signal (FIFOWr) carrying the write requests (FIFOWr=1);

a first incrementing device 519 configured to receive the active value (WrPtr) of the write pointer and apply an incrementation step equal to the size of the input bus (FIFODin) (1 in this example), in order to provide the combinatorial value of the write pointer (WrPtrI);

a first multiplexer 520, generating an anticipated value (WrPtrNext) of the write pointer and having first and second inputs receiving, respectively, the active value (WrPtr) of the write pointer and the combinatorial value of the write pointer (WrPtrI), and a control input receiving the signal (FIFOWr) carrying the write requests, so that the anticipated value (WrPtrNext) of the write pointer is equal to the combinatorial value of the write pointer (WrPtrI), if the control input receives a write request (FIFOWr=1), or to the active value (WrPtr) of the write pointer, if the control input does not receive a write request (FIFOWr=0).

In order to generate the active (RrPtr) and anticipated (RrPtrNext) values of the read pointer, the interfacing device includes:

a fourth intermediate register 521 making it possible to sample and block the anticipated value of the read pointer (RdPtrNext), in order to provide at its output the active value (RdPtr) of the read pointer. This fourth intermediate register has an activation input (E) receiving the signal (FIFORdRq) carrying the read requests (FIFORdRq=1);

a fifth intermediate register 522 making it possible to sample and block an intermediate anticipated value (RdPtrNextI) of the read pointer, in order to provide at its output the anticipated value (RdPtrNext) of the read pointer. This fifth intermediate register has an inverted activation input (E) receiving the combinatorial memory empty indication signal (CmdFifoEmptyI);

an adder 523 making it possible to add the anticipated value (RdPtrNext) of the read pointer and the size (NbWords) of the instruction associated with an active read request, in order to generate the intermediate anticipated value (RdPtrNextI) of the read pointer.

Writing of Data

The microprocessor (master) writes the data on the input bus FIFODin and positions FIFOWr at “1”. The data is then written into the memory plane 51 via the write means 52. The entire set of flip-flops of the bank of registers forming the memory plane 51 sees the input bus FIFODin on their data input. The flip-flops whose index corresponds to the value of the write pointer WrPtr have their activation input (Enable) positioned at “1”. Additionally, the register WrPtr is incremented. WrPtrNext is the anticipated value for the pointer WrPtr in the case where a write operation is going to be performed. In the case where the memory plane 51 is full, the write abort signal FIFOWrAbort is positioned at “1”. The master must then lower its write request FIFOWr back down to “0”.

Reading of Data

Reading occurs when the input FIFORdRq is positioned at “1”. The data can be read at the FIFODout output when the read acknowledgement signal FifoRdAck equals “1”. The register RdPtrNext contains the anticipated value of the read pointer. This is computed from the previous value for RdPtrNext, by adding the value NbWords, which is an input of the FIFO. NbWords is a piece of information that provides the size of the next instruction to be read, which is attached onto the high-order bytes of FIFODoutNext. On the other hand, FIFODout can serve directly as an instruction register for the co-processor.

The size information NbWords is obtained by presenting to the slave the next assumed instruction (via FIFODoutNext) so as to retrieve the size (NbWords) there from. RdPtrNext can be updated only if the memory plane 51 is not empty (see the Enable input of the RdPtrNext register). The essential function of RdPtrNext is to perform an access operation in the bank of registers forming the memory plane 51, ahead of phase, because the transit times of the bank's output multiplexers are very long. Since access is anticipated, the data is sampled from all of the FIFODout registers, which makes it possible to have stable output data throughout an entire clock period.

Determination of the Empty State (CmdFifoEmptyI=0)

The passage of the signal CmdFifoEmptyI to “1”, i.e., the determination of the empty state of the memory plane, is carried out in an anticipatory way, so as to be able to sample the combinatorial signal CmdFifoEmptyI with the aid of the register referenced as 58, in order to read out the sequential signal CmfFifoEmpty (having a stable state over one clock period) bound for the co-processor (slave).

As explained above, this is based on the computation of a first distance WrNRdDistance (between the active value of the read pointer and the anticipated value of the write pointer), performed by a substraction operator.

The anticipated value of the read pointer is not used in this computation of distance because it is impossible to compute it since it depends on NbWords, which depends on FIFODoutNext. Such being the case, since the memory plane is empty, FIFODoutNext is not valid. This is a transient state: it passes from the FIFO EMPTY state to the FIFO NOT EMPTY state as soon as a piece of data is written. This data passes through the through transit mechanism (“pass-through”), and NbWords is then almost instantly updated in a combinatorial manner by the slave and is instantly compared to the distance WrNRdDistance so as to determine the value for CmdFifoEmptyI. That does not make it possible to use the anticipated value of the read pointer RdPtrNext, which would require an additional clock stroke in order to be updated again (because it is a sequential element).

Determination of the Full State (FIFOWrAbort=1)

The passage of the signal FIFOWrAbort to “1”, i.e., the determination of the full state of the memory plane, is accomplished by means of absurd reasoning. The anticipated computation for the second distance WrNRdNDistance (between the anticipated values of the read and write pointers) is used and the AlmostFull information that informs us about the fact that the memory plane contains more than “FiFoSize-MasterBusSize” words (FiFOSize is the size in words of the memory plane, and MasterBusSize is the size in words of the input bus FiFODin). If a write operation is detected (FIFOWr at “1”), the second anticipated distance is re-updated, but if the memory plane does not have enough memory workspace then the read pointer will be overshot by the write pointer. The anticipated distance will then pass from a value close to “FiFoSize-MasterBusSize” to a value close to 0 (in the case where there are several input buses of different sizes). In this way, an inconsistency is detected between the signal AlmostFull, which informs us about the fact that the memory plane is more than half full and that the second distance is near zero. This information then makes it possible to submit a write abort request to the master (FIFOWrAbort=1).

The logical reasoning leading to the computation of the value for the signal FIFOWrAbort will now be detailed by way of an example. During a reset operation (reset), the signal AlmostFull equals “0”. When at least “FIFOSize-MasterBusSize” words are present in memory, the second distance WNrRdNDistance is consequently greater than or equal to “FIFOSize-MasterBusSize” and the signal AlmostFull assumes the value “1”. In the case where the memory plane has a size of 64 words, the maximum distance between the pointers RdPtrNext and WrPtrNext is 63 and is contained by the register WrNRdNDistance, which is encoded on 6 bits. If a write request is detected (FIFOWr passes to “1”) and if WrNRdNDistance is equal to 63, WrNRdNDistance will be updated and assume a value close to 0 (0, 1 ,2 . . . based on the size of the input bus FIFODin which, in this example, is equal to 1). WrNRdNDistance(HighorderBit)=WrNRdNDistance(5), which contained the value “1”, passes to “0”. The output FIFOWrAbort will then pass from “0” to “1”. AlmostFull can no longer be updated because its inverted Enable input is at “1”. As long as the second anticipated distance does not reassume a value close to “FIFOSize-MasterBusSize”, FIFOWrAbort is kept at “1”. AlmostFull will assume the value “0” when the distance reassumes a coherent value, i.e., close to FIFOSize, and when the distance WrRdDistance goes below the value “FIFOSize-MasterBusSize”.

Determination of the Validity of the Read Data (WordValid=1)

The computation of the value of the signal WordValid makes it possible to determine if the computation of anticipated distance is valid or not. Indeed, the latter is valid only if there have been more write operations than read operations in the memory plane, because the anticipated determination depends on NbWords, which depends on the data FiFODoutNext. If the memory plane is empty, the anticipated computation is performed with NbWords resulting from the decoding of an undetermined value, which may be a preceding write operation. It is then said that if the pointers are aligned, and in the case where AlmostFull is in the “0” state, then the data is not valid, because the anticipated computation is erroneous. The AlmostFull information is used, in addition to the comparison of RdPtr and WrPtr, because the latter can be aligned in the case where the plane is full, and the data is then valid.

Acknowledgement of the Read Request

The read acknowledgement signal FiFORdAck is positioned at “1” when the memory plane is not empty (CmdFifoEmpty=0) and when the signal WordValid is at “1”. The data on FIFODout is then considered well-formed and can be read by the slave.

Differentiation Between the Pointers WrNRdDistance AND WrNRdNDistance

The device of FIG. 5 is designed for operating in a transient and steady state. The steady state is reached when the memory plane is non-empty and non-full. The transient state is reached during passages from the non-empty to the empty state, empty to the non-empty state, full to the non-full state and non-full to the full state. An attempt made to minimise time costs during transient states, which may be overriding in an application using a co-processor slaved by a microprocessor. Such being the case, in order to respond to the hardware problem (hardware) involving signal propagation delay, the read operation is anticipated in the memory plane. The latter is accomplished by selecting the words to be read with the aid of multiplexers whose transit times are considerable. This anticipation is assumed by the anticipated value RdPtrNext of the read pointer, which is obtained by incrementing it by the value NbWords (number of words of the next presumed instruction). In the case where the memory plane is empty, the next instruction is not known since it has not been written, and therefore Nbwords is unknown. RdPtrNext must not be updated. As soon as the anticipated opcode is positioned on the input bus FIFODin, it is propagated in a combinatorial manner (almost instantaneously) onto the bus FIFODoutNext, and NbWords is then updated; CmdFifoEmptyI may thus assume the value “00” if the sufficient number of words has been written in order for the instruction to be well-formed. This is why a dedicated distance computation is required: WrNRdDistance. This distance is compared to NbWords, which amounts to comparing the distance between the future values for the read and write pointers, without any penalty in terms of clock stroke. Indeed, this is a transient state and RdPtrNext would require an additional clock stroke in order to assume the value “RdPtr+NbWords” (knowing that RdPtrNext is a sequential element and that, when the memory plane is empty, RdPtrNext is no longer updated). This anticipated computation of distance makes it possible to gain a clock stroke in comparison with a mechanism using the comparison of RdPtrNext and WrPtrNext, because the latter would require a clock stroke in order for RdPtrNext to be re-updated after NbWords was re-updated, and then a second clock stroke in order that the register referenced as 58 might sample CmdFifoEmptyI in order to obtain CmdFiFoEmpty. The device presented requires only a single clock stroke in order for CmdFifoEmpty to consider updating NbWords.

Alternative With a Single Distance Computation

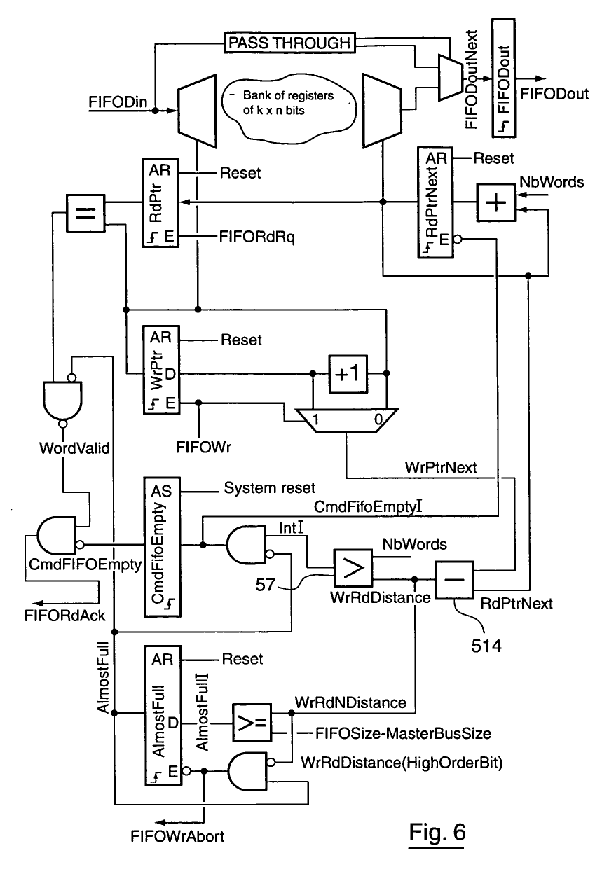

FIG. 6 is a logic diagram of a second particular embodiment of the interfacing device.

This alternative of the first embodiment shown in FIG. 5 is distinguished solely in that the second distance WrNRdNDistance (called WrRdDistance in the remainder of the description of this alternative) is used in place of the first distance WrNRdDistance, at the input of the means of comparison referenced as 57. This makes it possible to eliminate the subtraction operator referenced as 56 in FIG. 6. In other words, only the subtraction operator referenced as 514 in FIG. 6 is kept.

Indeed, rather than computing two distances: WrNRdNDistance and WrNRdDistance separated for the determination, in one case, the empty state and, in the other case, the full state of the memory plane, it is possible to compute only one distance: WrRdDistance, which is the distance between the anticipated write pointer and the anticipated read pointer. The resulting distance can be used in place of WrNRdNDistance and WrNRdDistance in a manner equivalent to the device shown in FIG. 5. Indeed, in the case where the memory plane is empty, CmdFifoEmpty equals “1”. RdPtrNext is thus no longer updated because the inverted activation input (Enable) of the corresponding register equals “1”. In this case, RdPtrNext=RdPtr. This saves a subtraction operator in order to perform a distance computation.

Illustration of the Optimal Feature

FIG. 4 shows an example of filling a 64-word size memory plane of an interfacing device.

Using the interfacing device of the invention (adaptive FIFO), an instruction is allocated the exact number of physical locations of the memory that are required for storing the words of this instruction (no stuffing word).

Thus, it is seen in FIG. 4 (example of filling a memory plane of an interfacing device), by comparison with FIG. 3 (example of filling a memory plane of an interfacing device according to the prior art), that, in the case where the two memory planes of the same size are in a full state (64 words used), the memory plane of the interfacing device contains more commands than that of the prior art.

Detail of the Through Transit Mechanism (Pass-Through)

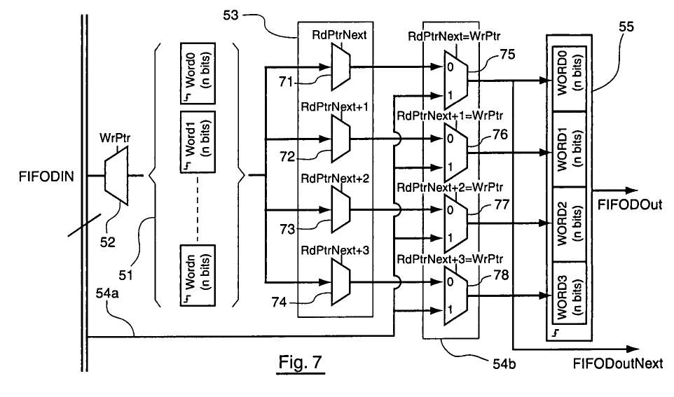

The aforesaid pass-through mechanism appearing in FIGS. 5 and 6 will now be presented in greater detail, in relation to FIG. 7.

Found again in FIG. 5 are the elements referenced as 51, 52, 53, 54a, 54b and 55.

The interfacing device includes:

a detector 54b configured to detect a change in state, making it possible to detect a passage from an “empty memory” state to a “non-empty memory” state;

through transit mechanism 54a, making it possible to position data present on the input bus (FIFODin) directly at the input (FIFODoutNext) of the bank of output registers, without being previously written into the memory plane, if the detector 54b makes a positive detection.

It shall be noted that the detector 54b can include multiplexers, referenced as 75 to 78, whose control signals result from comparisons based on the active value (WrPtr) of the write pointer and the anticipated value (RdPtrNext) of the read pointer.

It shall also be noted that the read access mechanism (second address decoder) 53 can include multiplexers, referenced as 71 to 74, whose control signals result from comparisons based on the anticipated value (RdPtrNext) of the read pointer. This makes it possible to have short data paths.

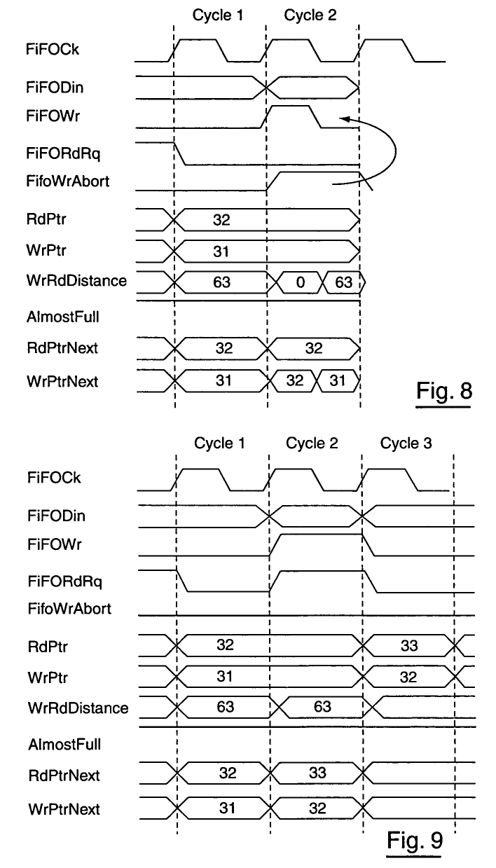

Discussion of the Timing Charts of FIG. 8

FIG. 8 shows signal timing charts illustrating an example of the passage to the “true” value of a write abort signal (FIFOWrAbort=1) generated by an interfacing device.

The memory plane is managed like a rotating FIFO. The write pointer always precedes the read pointer because only the data written beforehand must be read. In this example, it is assumed that the memory plane comprises 64 words and one is situated at a moment where RdPtr is equal to 32 and WrPtr is equal to 31 (the write pointer will catch up with the read pointer). Thus, 64 words have been written and the memory plane is full. If a new piece of data is written, then the next data to be read is overwritten and the memory plane is then corrupted. During cycle 1, the computed distance is 63 (31-32=63 using a digital substraction operator whose operands and outputs are defined on 7 bits). During cycle 2, a write operation is detected (FIFOWr=1). WrPtrNext assumes the value WrPtr+1 and the computation of the distance passes to 0. This distance is zero in the same way when the memory plane is empty. But this information coupled with AlmostFull, which is equal to “1”, indicates that the memory plane is full, which generates the information FIFOWrAbort=1. The latter is used to abort the write operation of the master by forcing the microprocessor to be in idle mode (idle), resulting in FIFOWr falling over the falling edge of cycle 2 because, in this example, the idle mode of the microcontroller is acknowledged on the falling edge. The falling of FIFOWr is therefore a direct consequence of the information FIFOWrAbort=1. The microprocessor will remain in idle mode as long as slave read operations have not been carried out and released a number of elementary words at least equal to the size of the input bus (FIFODin bus size).

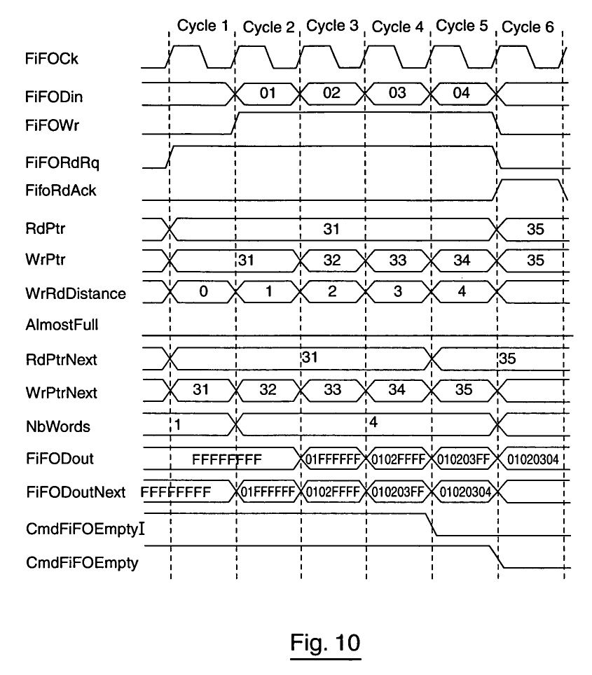

Discussion of the Timing Charts of FIG. 9

FIG. 9 shows signal timing charts illustrating an example of the maintaining at the “false” value of a write abort signal (FIFOWrAbort=0) generated by an interfacing device.

In this case, the memory plane has no more free space because the distance is 63. During cycle 2, a piece of data is consumed by the slave while the master provides one. The next value RdPtrNext of the read pointer is incremented as well as the next value WrPtrNext of the write pointer. The distance “WrPtrNext

RdPtrNext” remains constant, and thus FIFOWrAbort remains in the low state.

Discussion of the Timing Charts of FIG. 10

FIG. 10 shows signal timing charts illustrating an example of the passage to the “true” value of a read acknowledgement signal (FIFORdAck=1) generated by an interfacing device.

At cycle 1, the memory plane is empty. During cycles 2, 3 and 4, data is written into the FIFO, and the distance is incremented but remains lower than NbWords (in this case NbWords=4). CmdFiFOEmptyI thus remains at “1”. At cycle 5, WrRdDistance passes to 4. Thus, NbWords>WrRdDistance, which is no longer verified. CmdFiFOEmptyI thus passes to “0” and, at cycle 6, CmdFiFOEmpty likewise passes to “0”. At cycle 6, FifoRdAck then passes to “1”.

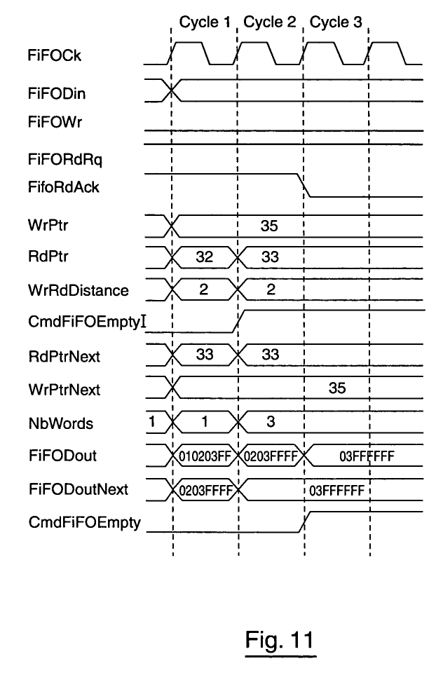

Discussion of the Timing Charts of FIG. 11

FIG. 11 shows signal timing charts illustrating an example of the passage to the “false” value of the read acknowledgement signal (FIFORdAck=0) generated by an interfacing device.

The case of the embodiment of FIG. 6 is used here for computing distance: only one distance is computed, which is called WrRdDistance (distance between the anticipated values WrPtrNext and RdPtrNext for the write and read pointers).

At cycle 1, the memory plane contains 3 words. The instruction whose opcode is “01” is being executed. FIFODoutNext shows that the opcode of the next instruction to be executed is “02” and it is assumed that the latter has a size of 1 word. At cycle 2, the opcode of the next instruction is “03” and it is assumed that the latter comprises 3 words. NbWords>WrRdDistance, thus CmdFiFOEmptyI passes to “1”. From that time forward, RdPtrNext can no longer be updated and WrRdDistance remains at 2. At cycle 3, CmdFiFOEmptyI is sampled, CmdFiFOEmpty passes to “1”, and FifoRdAck then passes to “0”.

Summary of the Advantages of the Invention

Storage/Restoration of Variable-Size Instructions

In the case of a master/slave application, the master can write a well-formed instruction (or more generally speaking a word group) one or more times based on the bandwidth. Thus, in the example presented above, it writes the words one-by-one (the size of FiFODin equals 1). The slave waits for NbWords to be written in order to consider the data (i.e., the instruction) as being well-formed.

Anticipated computation device is then used, making it possible to compute the distance between the anticipated value of the write pointer and the active value of the read pointer. If this distance is greater than or equal to NbWords, then the data is considered well-formed.

Writing of the Data Carried Out Either One or More Times

The master uses the write means in order to fill the memory plane. They are composed of one or more multiplexers whose architecture and size depends on the width of the input bus (write bus). The write operation can be performed one or more times, for example, if the size of the data being written exceeds that of the write bus.

Instantaneous Availability of the Read Data as Soon as it is Well-Formed

So as to optimise utilisation of the memory plane, the data must be available immediately. A CPU/DSP system operates this type of interfacing device (FIFO) most of the time in the transient state. Therefore it is desirable to not penalise this type of state. That occurs when one passes from the FIFO empty state to the FIFO full state. To accomplish that, a through transit mechanism (pass-through) is used. That makes it possible to transport the data present on the bus FIFODin and to position it directly in the output registers (output signal FIFODout). In the case of FIG. 7, address comparators and multiplexers are required in order to write either the data coming from the memory plane or the data present on the bus FIFODin. In the genericity section below, we return to the possibility of having a write bus of k×n bits, which makes it necessary to compare the addresses RdPtrNext/Wr, RdPtrNext/Wr+1 . . . RdPtrNext/Wr+k for each of the n-bit registers of FIFODout.

Furthermore, in steady state, the data comes from the memory plane. In this case, anticipated address computation mechanisms are used so as to sample a clock stroke in advance of the next data that will be read.

Design Tolerating High Operating Frequencies

The critical paths are the access paths into the memory plane and the paths passing through the computation operators for the pointers. The use of anticipated computation of the address, makes it possible to perform staggered reading of data. Said reading has one clock period in which to be performed (transit of the read means of the memory plane) . The use of anticipated computation (registers RdPtrNext and WrPtrNext) makes it possible to have short data paths. The anticipated value RdPtrNext of the read pointer is computed so as to access the data from the memory plane in parallel with the processing of the information FIFODout by the slave unit. Indeed, accessing the data takes a long time, due to the transit of the multiplexers enabling the read operation.

Genericity

Aspects of the invention work for any size memory plane, insofar as the transit time for the address decoders is less than the system's clock period.

The master unit may have several write buses of different sizes so as to optimise the loading times.

The size of FIFODout may comprise n elementary words. The number of address comparators and multiplexers for the through transit mechanism (pass-through) is therefore affected by it.

In one alternative embodiment, the output registers are transferred to the slave unit. The latter then receives only FIFODoutnext and thus itself computes FIFODout by re-sampling FIFODoutNext.

Although the subject matter has been described in language specific to structural features and/or methodological acts, it is to be understood that the subject matter defined in the appended claims is not limited to the specific features or acts described above as has been held by the courts. Rather, the specific features and acts described above are disclosed as example forms of implementing the claims.

What is claimed is:

1. An interfacing device, of the type enabling one-way interfacing between a master unit and a slave unit, and comprising:
a memory plane managed according to a “first in, first out” mode, with write and read pointers, and making it possible to store words coming from the master unit, via an input bus (FIFODin);
a bank of output registers capable of containing words read in the memory plane and providing an output signal (FIFODout) capable of being read by the slave unit;
a mechanism configured to receive read requests (FIFORdRq=1) coming from the slave unit and write requests (FIFOWr=1) coming from the master unit, each read request requiring the reading of a word group;
a mechanism configured to receive, for each read request, the size (NbWords) of the word group associated with said read request, said size being variable from one read request to the other; and
a mechanism configured to acknowledge read requests, generating, for each read request, an acknowledgement signal with a “true” value (FIFORdAck=1) if a number of words at least equal to the size (NbWords) of the word group associated with said read request is available on the output signal (FIFODout) of the bank of output registers.

2. The interfacing device of claim 1, and further comprising a mechanism configured to provide the slave unit with a signal (FIFODoutNext) present at the input of the bank of output registers, and which is an anticipated value for the output signal (FIFODout) of the bank of output registers, so that, while the interfacing device is serving an active read request, the slave unit might obtain, in an anticipatory way, an assumed value of a word group associated with a next read request and provide the interfacing device with the size (NbWords) of the word group associated with said next read request.

3. The interfacing device as claimed in claim 1, wherein said acknowledgement mechanism includes:
a computing device configured to compute a first distance (WrNRdDistance) between, on the one hand, an anticipated value (WrPtrNext) of the write pointer, an advance clock stroke, and, on the other hand, an active value (RdPtr) of the read pointer;
a first comparator configured to compare the size (NbrWords) of the word group associated with an active read request, with said first distance, so that if said size is not greater than said first distance, the first comparator generates a combinatorial memory empty indication signal with a “false” value (CmdFifoEmptyI=0);
a first intermediate register making it possible to sample and block said combinatorial memory empty indication signal (CmdFiifoEmptyI), in order to provide at its output a sequential memory empty indication signal (CmdFifoEmpty);
a first mechanism configured to generate the acknowledgement signal with the “true” value (FIFORdAck=1), if the first intermediate register provides at its output said sequential memory empty indication signal with the “false” value (CmdFifoEmpty=0).

4. The interfacing device of claim 3, and further comprising a mechanism configured to generate a sequential, almost full memory indication signal (AlmostFull),
and in that said acknowledgement mechanism further includes a second mechanism configured to generate the combinatorial memory empty indication signal with the “true” value (CmdFifoEmptyI=1) only if said size is greater than said first distance and if said sequential almost full memory indication signal assumes the “false” value (AlmostFull=0).

5. The interfacing device of claim 3, wherein said acknowledgement mechanism further include a mechanism, configured to generate a validity signal for the computation of the first distance (WordValid),
and in that said first mechanism is configured to generate the acknowledgement signal with the “true” value (FIFORdAck=1) if said sequential, memory empty indication signal has the “false” value (CmdFifoEmpty=0) and if said validity signal for the computation of the first distance has the “true” value (WordValid=1).

6. The interfacing device of claim 5, and further comprising a mechanism configured to generate a sequential, almost full memory indication signal (AlmostFull),
and in that said mechanism configured to generate the validity signal for the computation of the first distance (WordValid) includes:
a detector configured to detect an alignment of the active values (WrPtr, RdPtr) for the write and read pointers, and generating an alignment signal with the “true” value, in the case of alignment;
a third mechanism configured to generate said validity signal for the computation of the first distance with the “false” value (WordValid=0) only if said alignment signal assumes the “true” value and if said sequential, almost full memory indication signal assumes the “false” value (AlmostFull=0).

7. The interfacing device as claimed in claim 1, and further comprising a mechanism configured to abort write requests, generating an abort signal (FIFOWrAbort) and themselves include:
a mechanism configured to generate a sequential, almost full memory indication signal (AlmostFull);
a mechanism configured to compute a second distance (WrNRdNDistance) between, on the one hand, an anticipated value (WrPtrNext) of the write pointer, an advance clock stroke, and, on the other hand, an anticipated value (RdPtrNext) of the read pointer, an advance clock stroke;
a fourth mechanism configured to generate an abort signal with the “true” value (FIFOWrAbort=1) if the sequential, almost full memory indication signal assumes the “true” value (AlmostFull=1) while said second distance (WrNRdNDistance) is near zero.

8. The interfacing device of claim 7, wherein said fourth mechanism includes a logic gate AND having:
a first inverted input receiving the high-order bit of said second distance (WrNRdNDistance);
a second input receiving said sequential, almost full memory indication signal (AlmostFull);
an output issuing said abort signal (FIFOWrAbort).

9. The Interfacing device as claimed in claim 4, wherein said mechanism configured to generate the sequential, almost full memory indication signal (AlmostFull) themselves include:
a mechanism configured to compute a second distance (WrNRdNDistance) between, on the one hand, an anticipated value (WrPtrNext) of the write pointer, and advance clock stroke, and, on the other hand, an anticipated value (RdPtrNext) of the read pointer, an advance clock stroke;
second comparator, making it possible to compare said second distance with a determined threshold value, so that, if said second distance is greater than or equal to said threshold value, the second means of comparison generate a combinatorial, memory almost full indication signal with a “true” value (AlmostFullI=1);
a second intermediate register making it possible to sample and block said combinatorial, memory almost full indication signal (AlmostFullI), in order to provide at its output said sequential, memory almost full indication signal (AlmostFull).

10. The interfacing device of claim 9, wherein said determined threshold value is equal to the difference between the size of the memory plane and the size of the input bus (FIFODin).

11. The interfacing device as claimed in claims 7 and 9 wherein said second intermediate register has an inverted activation input (E) receiving said abort signal (FIFOWrAbort).

12. The interfacing device as claimed in claim 3, and further comprising:
a third intermediate register, making it possible to sample and block a combinatorial value of the write pointer (WrPtrI), in order to provide at its output said active value (WrPtr) of the write pointer, said third intermediate register having an activation input (E) receiving the signal (FIFOWr) carrying said write requests;
a first incrementing device configured to receive said active value (WrPtr) of the write pointer and applying an incrementation step equal to the size of the input bus (FIFODin), in order to provide said combinatorial value of the write pointer (WrPtrI);
a first multiplexer configured to generate said anticipated value (WrPtrNext) of the write pointer and having first and second inputs receiving, respectively, said active value (WrPtr) of the write pointer and said combinatorial value of the write pointer (WrPtrI), and a control input receiving the signal (FIFOWr) carrying said write requests, so that said anticipated value (WrPtrNext) of the write pointer is equal to said combinatorial value of the write pointer (WrPtrI), if the control input receives a write request (FIFOWr=1), or to said active value (WrPtr) of the write pointer, if the control input does not receive a write request (FIFOWr=0).

13. The interfacing device as claimed in claim 1, and further comprising a mechanism configured to access the memory plane during reading, using, for each read access, an anticipated value (RdPtrNext) of the read pointer, an advance clock stroke.

14. The interfacing device as claimed in claim 7, and further comprising:
a fourth intermediate register making it possible to sample and block said anticipated value of the read pointer (RdPtrNext), in order to provide at its output said active value (RdPtr) of the read pointer, said fourth intermediate register having an activation input (E) receiving the signal (FIFORdRq) carrying said read requests;
a fifth intermediate register making it possible to sample and block an anticipated intermediate value (RdPtrNextI) of the read pointer, in order to provide at its output said anticipated value (RdPtrNext) of the read pointer;
an adder, making it possible to add said anticipated value (RdPtrNext) of the read pointer and the size (NbWords) of the word group associated with an active read request, in order to generate said anticipated intermediate value (RdPtrNextI) of the read pointer.

15. The interfacing device as claimed in claim 3, wherein said fifth intermediate register has an inverted activation input (E) receiving said combinatorial, memory empty indication signal (CmdFifoEmptyI).

16. The interfacing device of claim 15, wherein said mechanism configured to compute a first distance (WrNRdDistance) are replaced by said means of computing a second distance (WrNRdNDistance), so that said second distance (WrNRdNDistance) is used in place of said first distance (WrNRdDistance).

17. The interfacing device as claimed in claim 1, and further comprising:
a detector configured to detect a change of state, making it possible to detect a passage from a “memory empty” state to a “non-empty memory” state;
a direct pass-through mechanism, making it possible to position data present on the input bus (FIFODin) directly at the input (FIFODoutNext) of the bank of output registers, without previously being written into the memory plane, if said means of detection make a positive detection.

18. The interfacing device of claim 17, wherein said detector is configured to perform comparisons based on an active value (WrPtr) of the write pointer and an anticipated value (RdPtrNext) of the read pointer, an advance clock stroke.

19. The interfacing device as claimed in claim 1, wherein said bank of output registers (55) is transferred to the slave unit.

20. The interfacing device as claimed in claim 1, wherein the master unit is a microprocessor, in that the slave unit is a co-processor and in that each word group for which reading is requested by a read request includes an operation code word (opcode) and N operand words, with N≧0.

21. A slave unit, of the type designed to cooperate with a master unit via a one-way interfacing device, said slave unit comprising:
a mechanism configured to transmit read requests (FIFORdRq=1) to the interfacing device, each read-request requiring the reading of a word group;
a mechanism configured to read an output signal (FIFODout) of a bank of output registers capable of containing words read in a memory plane of the interfacing device;
a mechanism configured to transmit, for each read request, the size (NbWords) of the word group associated with said read request, said size being variable from one read request to the other; and
a mechanism configured to receive, for each read request, an acknowledgement signal (FIFORdAck) coming-from the interfacing device and having a “true” value (FIFORdAck=1) if a number of words at least equal to the size (NbWords) of the word group associated with said read request is available on the output signal (FIFODout) of the bank of output registers.

22. The slave unit of claim 21, and further comprising:
a mechanism configured to receive a signal (FIFODoutNext) present at the input of the bank of output registers, and which is an anticipated value for the output signal (FIFODout) of the bank of output registers;
a mechanism configured to obtain, from said signal (FIFODoutNext) present at the input of the bank of output registers, an assumed value for a word group associated with a next read request, while the interfacing device serves an active read request;
a mechanism configured to obtain and transmit to the interfacing device the size (NbWords) of the word group associated with said next read request.

23. The slave unit as claimed in claim 21, and further comprising a bank of output registers.

24. The slave unit as claimed in claim 21, wherein the slave unit is a co-processor and in that each word group whose reading is requested by a read request includes an operation code word (opcode) and N operand words, with N≧0.

25. A master unit, of the type designed to cooperate with a slave unit via a one-way interfacing device, said master unit comprising:
a mechanism configured to transmit write requests (FIFOWr=1) to the interfacing device;
a mechanism configured to transmit, on an input bus (FIFODin) of the interfacing device, data words to be written into the interfacing device;
a mechanism configured to receive, for each write request, an abort signal (FIFOWrAbort) coming from the interfacing device and having a “true” value (FIFOWrAbort=1) if said write request must be aborted by the master unit;
wherein said mechanism configured to transmit data words sends only words included in word groups intended to be read by the slave unit, no stuffing word being added.

26. A master unit of claim 25, wherein the master unit is a microprocessor and in that each word group intended to be read by the slave unit includes an operation code word (opcode) and N operand words, with N≧0.
